(19) United States
(12) Patent Application Publication
(10) Pub. No.: US 2013/0290452 A1
(43) Pub. Date: Oct. 31, 2013

(54) COLLEGE AND FINANCIAL AID TRACKING

(71) Applicant: Lynell Shore Engelmyer, Niskayuna, NY (US)

(72) Inventor: Lynell Shore Engelmyer, Niskayuna, NY (US)

(21) Appl. No.: 13/870,029

(22) Filed: Apr. 25, 2013

Related U.S. Application Data
(60) Provisional application No. 61/639,816, filed on Apr. 27, 2012.

(51) Int. Cl. G06F 15/173

(52) U.S. Cl. CPC G06F 15/17306
USPC 709/206; 709/219

(57) ABSTRACT

Methods and apparatus, including computer program products, for college admission and financial aid application tracking. A method includes, in a server residing in a network of interconnected computers, downloading admission and financial information from a plurality of web servers communicatively linked to the server, storing the downloaded admission and financial information in the local database, receiving registration information from user equipment communicatively linked to the server, receiving a college selection from the user equipment, matching the received college selection to admission and financial information in the local database, populating a dashboard with the matched college admission and financial information, receiving input from the user equipment through the dashboard, updating information in the dashboard in response to the received input, and sending a status report in response to the updated information.

### CROSS REFERENCE TO RELATED APPLICATIONS

This application claims the benefit of U.S. Provisional Application No. 61/639,816, filed Apr. 27, 2012. The disclosure of the prior application is considered part of and is incorporated by reference in the disclosure of this application.

### BACKGROUND OF THE INVENTION

The present invention generally relates to enterprise systems, and more particularly to college admission and financial aid tracking.

Each year over one and a half million students enter four-year colleges and universities. In order to gain admission to these institutions, students, most of whom are in their late teenage years, file numerous college applications, sometimes up to twelve or more.

College admission has become, and remains highly competitive, and teenagers are expected to follow a labyrinthine application process requiring multiple forms and work products to be completed on variable due dates and sub-dates. Admissions and financial aid filing requirements originate from disparate and non-complementary sources, and often require the student to orchestrate a process over which they do not have full control. Some students and parents flounder through this process and often miss crucial filing deadlines.

As students apply to an increasing number of colleges, the college admission and financial aid application process can become overwhelming and bewildering. This can be true of all families but particularly for low-income and/or first generation college students who are disproportionately affected by the difficulty of this process.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for identifying, tracking and reminding students of college admission and financial aid requirements and deadlines.

In general, in one aspect, the invention features a method including, in a server residing in a network of interconnected computers, the server comprising a processor, a memory and a local database, downloading admission and financial information from a plurality of web servers communicatively linked to the server, each of the web servers comprising at least a processor and a memory, storing the downloaded admission and financial information in the local database, receiving registration information from user equipment communicatively linked to the server, the user equipment comprising at least a processor and a memory, receiving a college selection from the user equipment, matching the received college selection to admission and financial information in the local database, populating a dashboard with the matched college admission and financial information, receiving input from the user equipment through the dashboard, updating information in the dashboard in response to the received input, and sending a status report in response to the updated information.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a block diagram of an exemplary system.

FIG. 2 is a flow diagram.

FIG. 3 is an exemplary registration wizard.

FIG. 4 an exemplary college user interface (UI).

FIG. 5 is an exemplary populated wizard.

FIG. 6 is an example applications detail UI.

FIG. 7 is an example testing dashboard.

FIG. 8 is an example essay dashboard.

FIG. 9 is an example financial aid information dashboard.

FIG. 10 is an example forms and recommendations dashboard.

FIG. 11 is an example contacts dashboard.

FIG. 12 is a sample set of dashboards.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

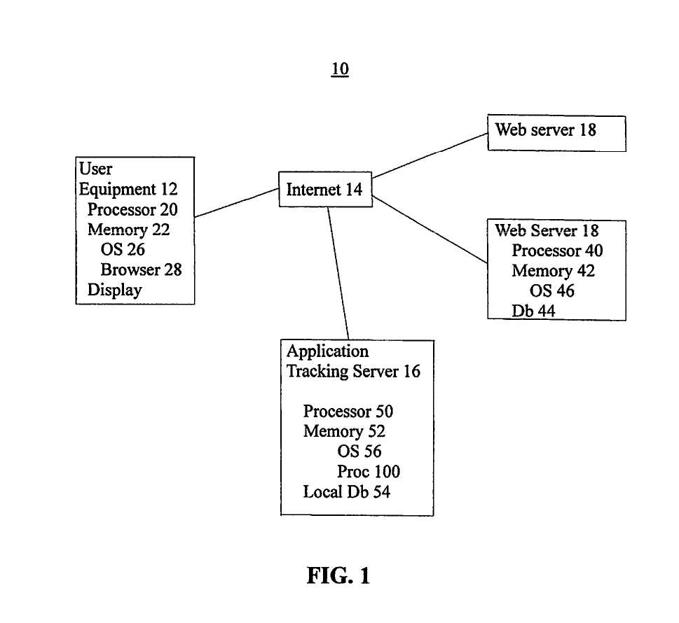

As shown in FIG. 1, an exemplary system 10 includes user equipment 12 communicatively linked to a network 14 of interconnected computers, e.g., the Internet. The link between the user equipment 12 and the Internet 14 can be wired or wireless. Example user equipment 12 includes, but is not limited to, desktop computers, laptops, notebooks, netbooks, tablets, personal data assistants, smartphones and so forth.

The system 10 includes an application tracking server 16 communicatively linked to the Internet 14, as well as one or more web servers 18. Examples of the one or more web servers 18 include, but are not limited to, servers that host public and private college and university websites.

The user equipment 12 includes a processor 20, a memory 22, and a display 24. The memory 22 includes an operating system 26, such as Windows®, Linux®, Unix®, iOS®, Android®, or RIM®, and a browser 28. The browser 28 enables a user to display and interact with applications and/or content residing in the application tracking server 16.

Each of the one or more web servers 18 includes at least a processor 40, a memory 42 and content database 44. The memory 42 an operating system 46. In one implementation, the content database 44 contains information related to a specific public or private college or university, including at least general information and admission information.

The application tracking server 16 includes a processor 50, a memory 52, and a database 54. The memory 52 includes an operating system 56 and an application tracking process 100. As will be fully described below, the application tracking process 100 enables a user, i.e., a college/university applicant, on the user equipment 12, to quickly and easily determine one or more schools' disparate filing requirements (both task and due date). With the application tracking process 100, a user can interactively modify and establish their own priority deadlines within the parameters set by each college/university, track completion of tasks and monitor outstanding deliverables. Users can also sort tasks in multiple formats including, by due date, tasks due by college/university, and tasks due by task type (e.g., list all essay requirements across multiple schools). The application tracking process 100 generates custom reminders to a user via email, SMS text message and/or social media, such as Facebook®.

The application tracking process 100 facilitates communication with parents and/or mentors and reduces tension between these parties around meeting college application requirements. The completion of tasks, outstanding tasks to be completed, and pending deadlines may be shared with parents, mentors, or counselors, relieving stress and anxiety through enhanced communication between teens and parents/mentors. An advantage of the present invention is the development of organizational skills of teenage users which is in its formative state at this point in their personal development.

The application tracking process 100 enables the user to select an unlimited number of colleges and universities for this college application process of which there are more than 3,000 in the United States alone. The application tracking process 100 populates a profile for each of applicant's selected colleges, drawn from its embedded database of information, to establish deadlines included but not limited to, filing deadlines, essay topics, applications and forms, storage of login information for multiple related websites, standardized testing requirements, transcripts, letters of recommendation, financial aid applications and related supplemental financial aid materials, alternative application requirements for athletes, artists, musicians, and so forth.

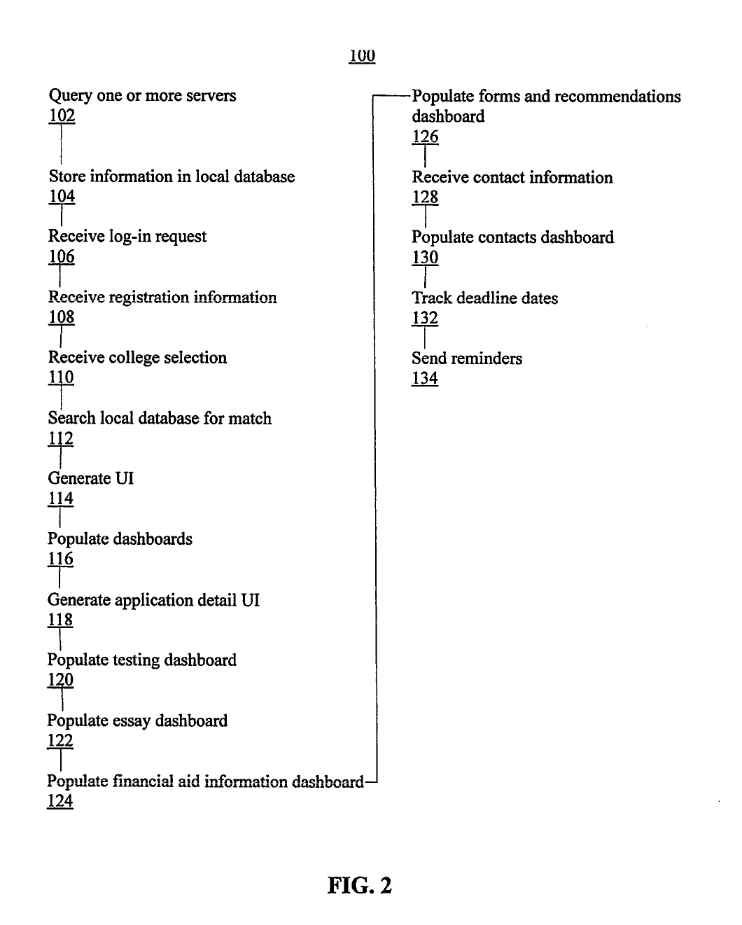

As shown in FIG. 2, the application tracking process 100 queries (102) the one or web servers 18 for information related to admission and financial aid applications and stores (104) the information in the database 54. The information stored in the database 54 may include the college's web site address, its physical address, a short description of the college, application information including application types, essay requirements, recommendation letter requirements, deadlines, financial aid filing requirements, including deadlines, standardized testing requirements, interview information, general scholarship information, tuition and fees, and so forth. Information gained from the one or more servers 18 may be stored and organized by college/university name, by college/university ID, and so forth. Once the database 54 is populated, its content represents disparate information pertaining to the college application process that is stored (104) in a single, organized database.

The application tracking process 100 receives (106) a log-in request from a user (also referred to as a “registrant” or “applicant”). In response, the application tracking process 100 receives (108) registration information from the user. This step is skipped if the user has previously registered with the application tracking process 100. The registration information is received (108) through registration user interface (UI), such as a dashboard or a wizard. In general, a wizard is a helper application that makes performing complex tasks easier. A wizard has a simple decision in a window, which contains Back and Next buttons underneath. When a user has filled in the required data, the user clicks the Next button to go to the next window, or the user can click the Back button to change a previous decision.

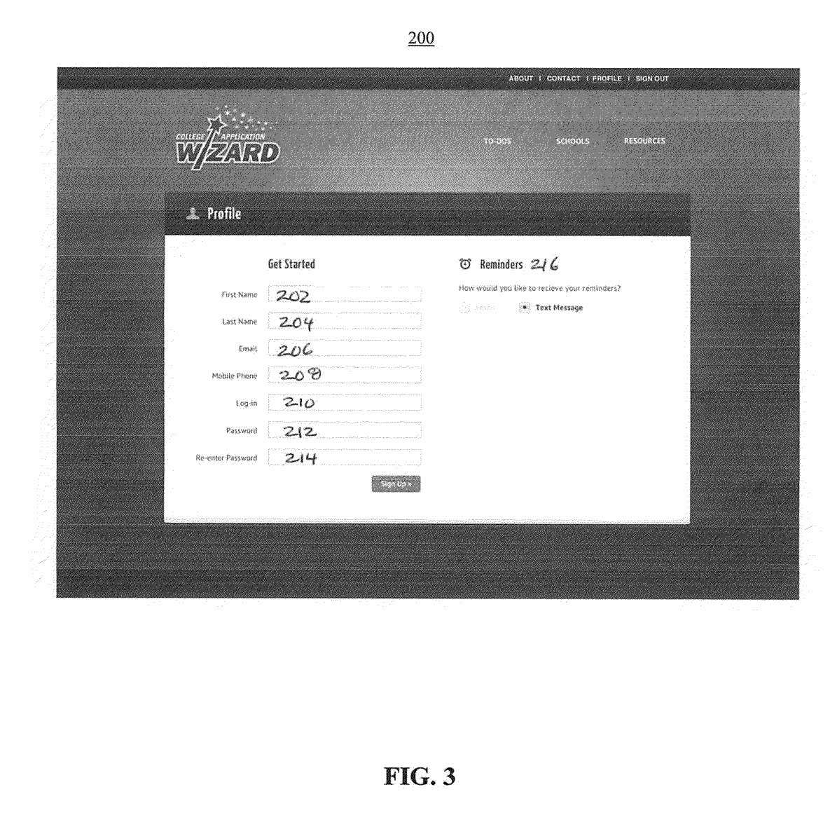

As shown in FIG. 3, an exemplary registration wizard 200 includes at least a First Name field 202, a Last Name field 204, an Email field 206, a Home Phone field 208, a Log-in Name field 210, a Password field 212 and a Re-enter Password field 214. The wizard 200 also includes a Reminders field 216. In implementations, the Reminders field 216 is populated with user entered information of how the registrant wishes to be notified/receive reminders (email, text message, phone call, and so forth), whether the registrant wants to include one or more mentors to receive read-only access to the registrant's account and whether/how the one or more mentors should be copied on notifications sent to the registrant. Applicants can invite a school counselor, or other supportive adult (e.g., parent, guardian, mentor, coach, and so forth) to monitor their application progress. For example, the registrant can include a school counselor (e.g., one or more mentors) to monitor their application progress. School counselors can have access to a computer user interface (e.g., dashboard) to track student progress in the college admission process. The registered applicant has the ability to customize messages. The counselors can view the dashboard to assist students in completing their college admissions tasks, including notifications sent to the registered applicant pertaining to deadlines or to comment on any other part of the process. All information entered is stored and editable by the registered user.

Although the application tracking process 100 can keep track of multiple college applications, for ease of description the application tracking process 100 will be described in the context of tracking a single college admission and financial aid application for a single college for a registered applicant.

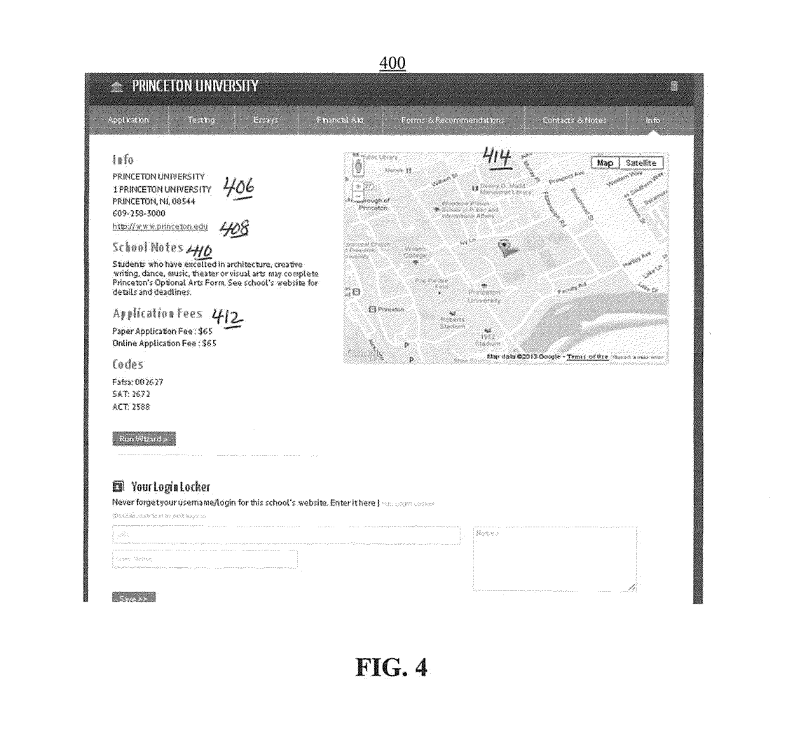

The application tracking process 100 receives (110) a college selection from the registrant. The application tracking process 100 searches (112) its database for a college matching the received selection and generates (114) a college user interface (UI). As shown in FIG. 4, an exemplary college UI 400 includes a name 402 of the selected college, school ID 404, address 406 and web address 408. Other information pertaining to the selected college is also displayed, including a quick facts 410, school log-in information 412 and a map 414 of its location. In implementations, the registrant is able to store a user ID they may need to create for each specific school.

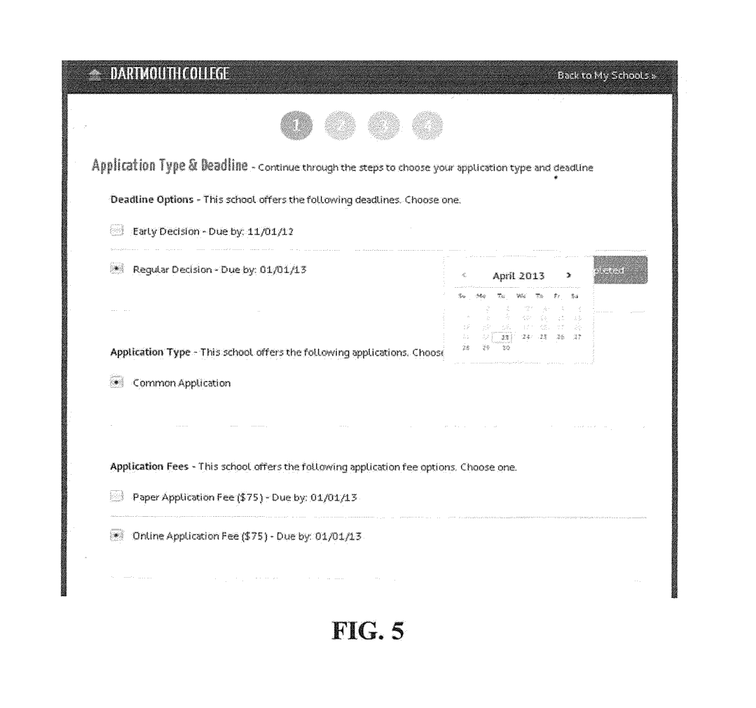

The application tracking process 100 populates (116) dashboards for the registrant with requirements pertaining to all aspects of the college admission and financial aid processes including, application options and fees, testing requirements, essay topics and word limits, financial aid filing requirements and deadlines, other required forms (including high school transcript, recommendations, and so forth). Examples of these populated dashboards are illustrated in FIG. 4 and FIG. 5.

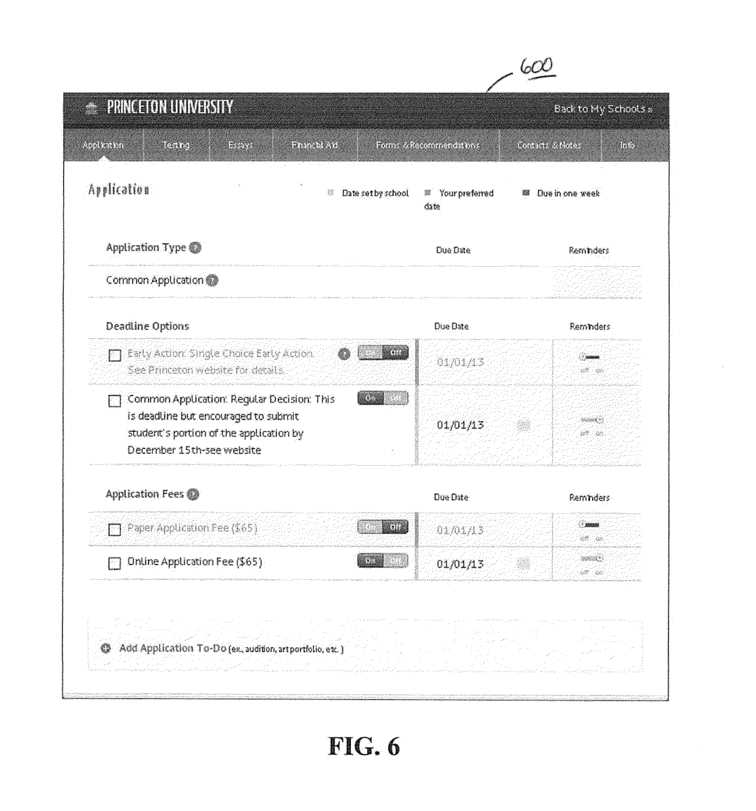

The application tracking process 100 generates (118) an applications detail user interface (UI). An example applications detail UI 600 is illustrated in FIG. 6. Application details can include information about whether the college accepts the Common Application, a school-specific application or a state-wide application. It can detail the date for early admission and date for regular decision and application fees for students filing either a paper application or an online application. Dates are editable so that an applicant can adjust them, if desired. The UI 600 includes an indication that The Common Application is accepted, along with the deadline dates for early admission and regular decision, respectively. The user chooses the deadline by which they will file, and the deadline dates for the remainder of the tasks are populated based on the items/dates in the database related to that particular application deadline for the selected institution of higher learning. In addition, the application fee and online application are shown. The application details UI 600 also enables the applicant to add new items. A musician, for example, might add the submission of an audition DVD as one of the application tasks.

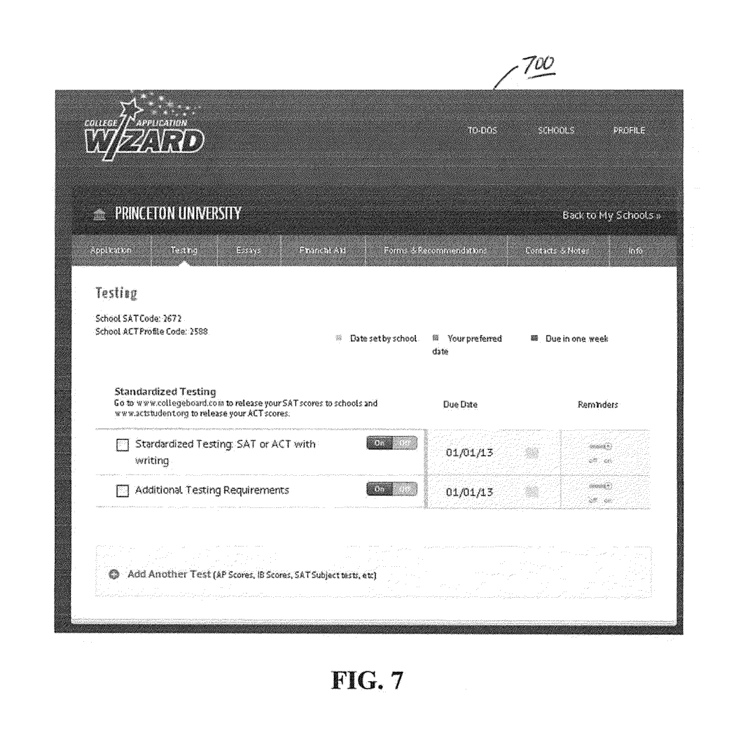

The application tracking process 100 populates (120) testing dashboard. An example testing dashboard 700 is illustrated in FIG. 7. Testing information can include standardized testing information and additional testing requirements. Here, dashboard 700 includes college codes for the SAT® and ACTS that the registrant must use when releasing their test scores to the college. The testing dashboard 700 also indicates other testing requirements such as SAT® Subject Tests. Here again, the registrant is provided with an option to add new or additional testing information which may be specific to the particular student.

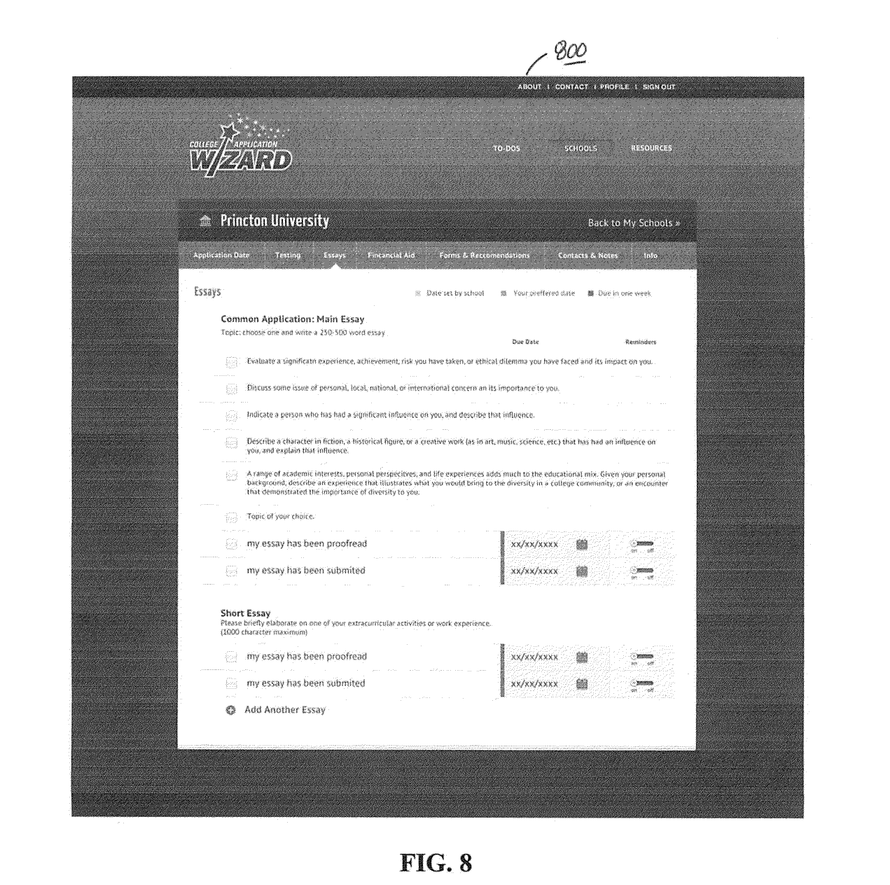

The application tracking process 100 populates (122) an essay dashboard. An example essay dashboard 800 is illustrated in FIG. 8 includes information related to the essay topic, a word limit or range, and deadlines for the essay(s). These deadlines may be altered by the applicant and checked off when completed. Additional notes and essay topics may also be added. To-do items are also created for having the essay proof-read.

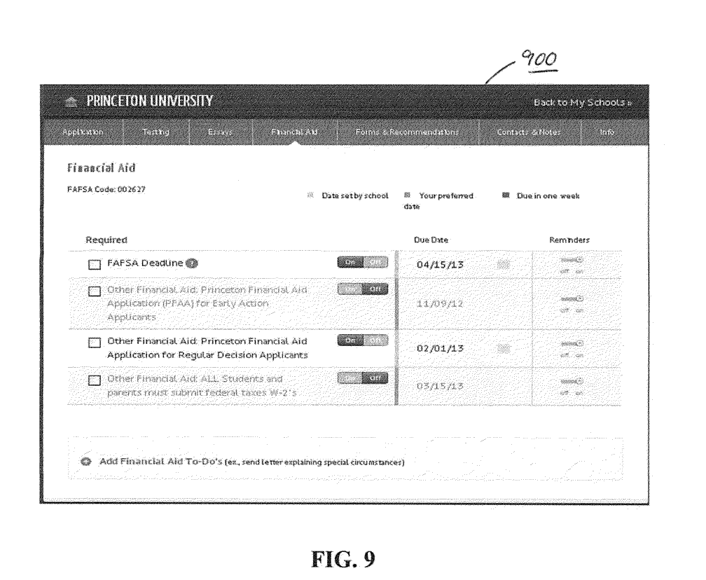

The application tracking process 100 populates (124) a financial aid information dashboard. An example financial aid information dashboard 900 is illustrated in FIG. 9 and includes deadlines for the universally required Free Application for Federal Student Aid and other financial aid requirements such as the CSS Profile Application, copies of student and parent(s) tax returns and W-2's. Additional notes or requirements may also be added.

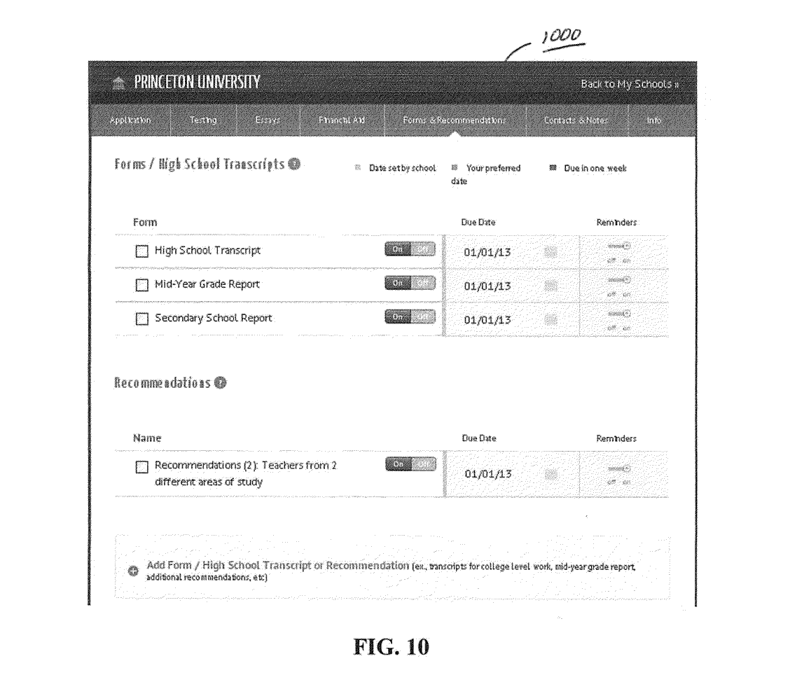

The application tracking process 100 populates (126) a forms and recommendations dashboard. An example forms and recommendations dashboard 1000 is illustrated in FIG. 10 and can include information and dates related to high school or college transcripts that must be forwarded to the college, letters of recommendation, mid-year grade reports, and so forth. Dates are user-editable. For example, an applicant may want reminders prior to the school's actual deadline so that they are not planning on meeting a last-minute deadline with no room to spare. Additional items may also be added.

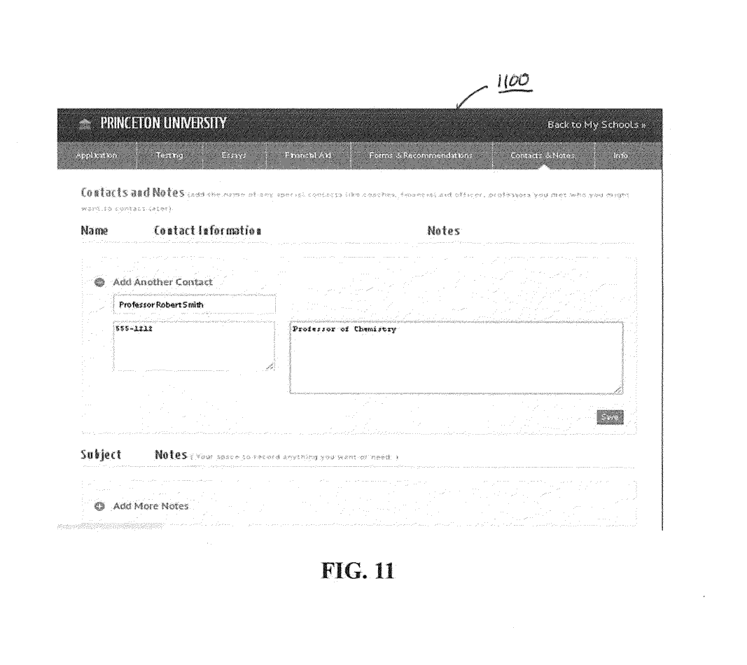

The application tracking process 100 receives (128) contact information from the registrant and populates (130) a contacts dashboard. An example contacts dashboard 1100 is illustrated in FIG. 11 and includes names and contact information of college or university personnel instrumental to the student like an interviewer, a coach, a faculty member, and so forth. The registrant is able to record information about the interview such as scheduled time, specific information on interview location, items the student should bring, and more. Additional notes may also be added.

Once information is added by the registered applicant, the application tracking process 100 tracks (132) deadline dates and sends (134) periodic reminders (also referred to as status reports) to the applicant and optionally to the applicant's one or more mentors by the method selected by the reminder recipient , i.e., text message (SMS), email, or social network. As application items required by the college are completed, the applicant indicates completion adjacent to the respective item in the appropriate dashboard or to-do list. No further reminders are then sent pertaining to any item indicated as completed by the applicant.

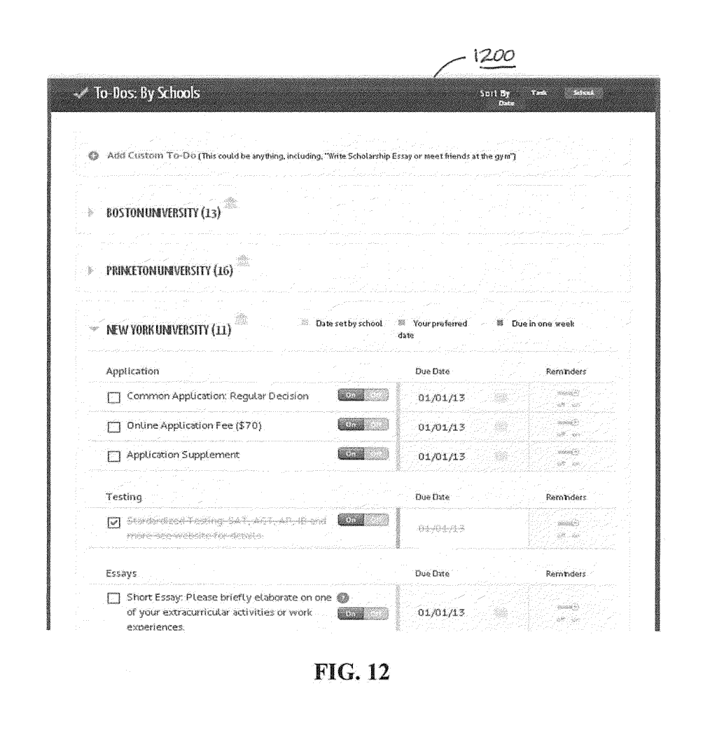

The applicant can query the application tracking process 100 for a calendar of upcoming events/deadlines for one or more of the colleges selected. The application tracking process 100 will display a list of completed and upcoming events pertaining to the one or more colleges. A sample set of dashboards 1200 displaying status information sorted by school (and by date within each school) is shown in FIG. 12. They can be sorted by due date across all schools, and they can be sorted by task (e.g., a list of all essays due across all schools).

Thus, the application tracking process 100 enables an applicant to create and manage a list of colleges and tasks, conveniently link to the college's own website, be notified of application deadlines, ensure that letters of recommendation, test scores and transcripts are sent on time, record essay prompts, stay updated about financial aid deadlines and materials, store interview dates, interview names and interview comments, notify one or more mentors about any and all of the above, through a series of customizable web-based dashboards.

Further, the application tracking process 100 enables an applicant to receive reminders prior to the school's actual deadline so that they are not planning on meeting a last-minute deadline with no room to spare.

As previously noted, the hardware and software systems in which the invention is illustrated are merely representative. The invention may be practiced, typically in software, on one or more machines. Generalizing, a machine typically comprises commodity hardware and software, storage (e.g., disks, disk arrays, and the like) and memory (RAM, ROM, and the like). The particular machines used in the system are not a limitation of the present invention. A given machine includes network interfaces and software to connect the machine to a network in the usual manner. The present invention may be implemented as a standalone product, or as a managed service (e.g., in an ASP model) using a set of machines, which are connected or connectable to one or more networks. More generally, the product or service is provided using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., Java applets or servlets, linkable libraries, native code, or the like, depending on platform), that provide the functionality of a given system or subsystem. As described, the product or service may be implemented in a standalone server, or across a distributed set of machines. Typically, a server connects to the publicly-routable Internet, a corporate intranet, a private network, or any combination thereof, depending on the desired implementation environment.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. Accordingly, other implementations are within the scope of the following claims.

What is claimed is:

1. A method comprising:
in a server residing in a network of interconnected computers, the server comprising a processor, a memory and a local database, downloading admission and financial information from a plurality of web servers communicatively linked to the server, each of the web servers comprising at least a processor and a memory;
storing the downloaded admission and financial information in the local database;
receiving registration information from user equipment communicatively linked to the server, the user equipment comprising at least a processor and a memory;
receiving a college selection from the user equipment;
matching the received college selection to admission and financial information in the local database;
populating a dashboard with the matched college admission and financial information;
receiving input from the user equipment through the dashboard;
updating information in the dashboard in response to the received input; and
sending a status report in response to the updated information.

2. The method of claim 1 wherein the registration information comprises a user name and a user password.

3. The method of claim 2 wherein registration information further comprises:
an email address of the user; and
a mobile phone number of the user.

4. The method of claim 3 wherein registration information further comprises:
a name of a second party;
an email address of the second party; and
a mobile phone number of the second party.

5. The method of claim 4 wherein the second party is a legal guardian of a registrant.

6. The method of claim 4 wherein the second party is a guidance counselor of a registrant.

7. The method of claim 1 wherein the admission and financial information comprises:
a college universal resource locator (URL);
the college physical address;
a short description of the college; and
application information including application types, essay requirements, recommendation letter requirements, deadlines, financial aid filing requirements, including deadlines, standardized testing requirements, interview information, general scholarship information, tuition and fees.

8. The method of claim 1 wherein the status report comprises completed items of admission.

9. The method of claim 1 wherein the status report comprises upcoming application deadlines.

10. The method of claim 1 wherein the status report comprises upcoming financial aid deadlines.

11. The method of claim 1 wherein the status report is sent to the user equipment.

12. The method of claim 3 wherein the status report is sent via Short Messaging Service (SMS) to the mobile phone number of the user.

13. The method of claim 3 wherein the status report is sent to the email address of the user.

14. The method of claim 4 wherein the status report is sent via Short Messaging Service (SMS) to the mobile phone number of the second party.

15. The method of claim 4 wherein the status report is sent to the email address of the second.
